(19) United States
(12) Patent Application Publication
(10) Pub. No.: US 2025/0191562 A1
(43) Pub. Date: Jun. 12, 2025

(54) SOUND OUTPUT DEVICE FOR VEHICLE

(71) Applicant: TOYODA GOSEI CO., LTD., Kiyosu-shi (JP)

(72) Inventors: Takumi ISHII, Kiyosu-shi (JP); Kazuhisa TAKAHASHI, Kiyosu-shi (JP); Koji FUKAGAWA, Kiyosu-shi (JP)

(21) Appl. No.: 18/947,343

(22) Filed: Nov. 14, 2024

(30) Foreign Application Priority Data
Dec. 6, 2023 (JP) 2023-206402
Mar. 18, 2024 (JP) 2024-042438

(51) Int. Cl. G10K 9/10; G10K 11/24; G10K 13/00

(52) U.S. Cl. CPC G10K 9/10; G10K 11/24; G10K 13/00

(57) ABSTRACT

A sound output device for a vehicle includes an external member body, a vibrator arranged at an inner side of the vehicle with respect to an exterior member body, and coupling portions coupling the exterior member body and the vibrator. The coupling portions are arranged on a circumference of an imaginary circle located on the inner surface of the exterior member body. The diameter of the imaginary circle and the frequency of vibration of the vibrator are set so that vibrations propagated through the coupling portions overlap each other in the center of the imaginary circle of the exterior member body.

### CROSS-REFERENCE TO RELATED APPLICATIONS

This application is based upon and claims the benefit of priorities from prior Japanese Patent Application No. 2023-206402, filed on Dec. 6, 2023, and prior Japanese Patent Application No. 2024-042438, filed on Mar. 18, 2024, the entire contents of each of which are incorporated herein by reference.

### BACKGROUND

### 1. Field

The present disclosure relates to a sound output device for vehicle.

### 2. Description of Related Art

Japanese Laid-Open Patent Publication No. 2011-246109 discloses an alarm generator that emits an alarm around the vehicle.

The alarm generator includes an oscillation unit attached to a body formation member exposed to the outside of the vehicle and an acoustic signal provision unit. The acoustic signal provision unit provides the oscillation unit with an acoustic electric signal for alarm. The oscillation unit includes an oscillator that converts the acoustic electric signal to a mechanical vibration. The vibration of the oscillator vibrates the body formation member. Thus, an alarm is emitted around the vehicle.

In the above-described generator, when the oscillation unit is attached to body formation members having different sizes and shapes and vibrates at the same frequency, the body formation members each may vibrate at a different frequency. Hence, sound waves emitted in accordance with vibration of the exterior member may have different frequencies.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect of the present disclosure, a sound output device for a vehicle includes an exterior member body including a portion of an outer shell of the vehicle, a vibrator arranged at an inner side of the vehicle with respect to the exterior member body and configured to vibrate when energized, and coupling portions projecting from an inner surface of the exterior member body and connecting the exterior member body to the vibrator. The sound output device is configured to vibrate the exterior member body using vibration of the vibrator propagated through the coupling portions and output a sound wave generated in accordance with the vibration of the exterior member body to an outside of the vehicle. The coupling portions are arranged on a circumference of an imaginary circle located on the inner surface of the exterior member body. A diameter of the imaginary circle and a frequency of the vibration of the vibrator are set so that vibrations propagated through the coupling portions overlap each other and are intensified in a center of the imaginary circle of the exterior member body.

Other features and aspects will be apparent from the following detailed description, the drawings, and the claims.

### BRIEF DESCRIPTION OF THE DRAWINGS

FIG. 1 is a perspective view showing an embodiment of a sound output device for a vehicle.

FIG. 2 is a front view of the sound output device shown in FIG. 1.

FIG. 3 is a cross-sectional view taken along line 3-3 in FIG. 1.

FIG. 4 is a diagram showing the relationship of diameters of an imaginary circle, frequencies of a vibrator, and distributions of absolute values of amplitude of vibration of an exterior member body.

FIG. 5 is a graph showing the relationship between the vibration frequency and the sound pressure level of sound waves in a hard resin fixing plate.

FIG. 6 is a graph showing the relationship between the vibration frequency and the sound pressure level of sound waves in a metal fixing plate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

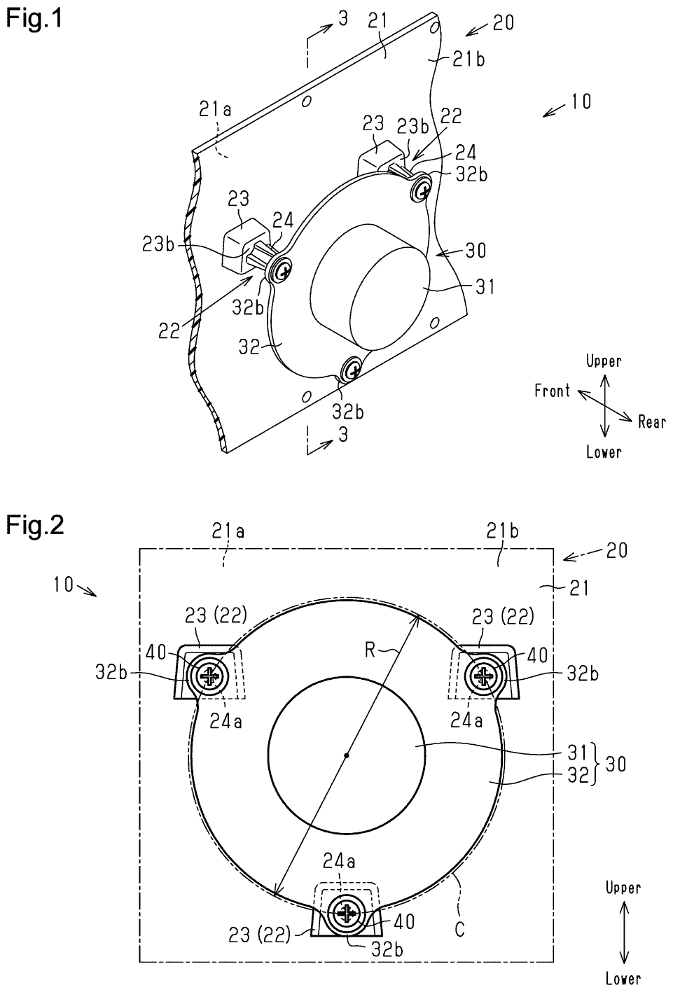

An embodiment of a sound output device for a vehicle will now be described with reference to FIGS. 1 to 6. The sound output device of the present embodiment is mounted on a vehicle (hereafter, referred to as subject vehicle). The sound output device outputs an approach notification sound to a walker approaching the subject vehicle.

In the description hereafter, the front-rear direction of the vehicle is simply referred to as the front-rear direction. The upper-lower direction of the vehicle is simply referred to as the upper-lower direction. In addition, the front side and the rear side in the front-rear direction are simply referred to as the front side and the rear side. The upper side and the lower side in the upper-lower direction are simply referred to as the upper side and the lower side.

As shown in FIGS. 1 to 3, a sound output device 10 is arranged on a front part of the vehicle. The sound output device 10 includes an exterior member 20 and a vibrator 30.

### Exterior Member 20

As shown in FIGS. 1 to 3, the exterior member 20 forms a portion of an outer shell of the vehicle. In an example, the exterior member 20 is a hard resin front cover.

The exterior member 20 includes an exterior member body 21 and coupling portions 22. The exterior member body 21 includes a front surface 21a including an ornamental surface located on the front surface of the vehicle and a rear surface 21b located opposite to the front surface 21a. The coupling portions 22 project from the rear surface 21b of the exterior member body 21.

The coupling portions 22 are formed integrally with the exterior member body 21. In the present embodiment, three coupling portions 22 are arranged on the exterior member body 21.

The coupling portions 22 each include a first part 23 and a second part 24.

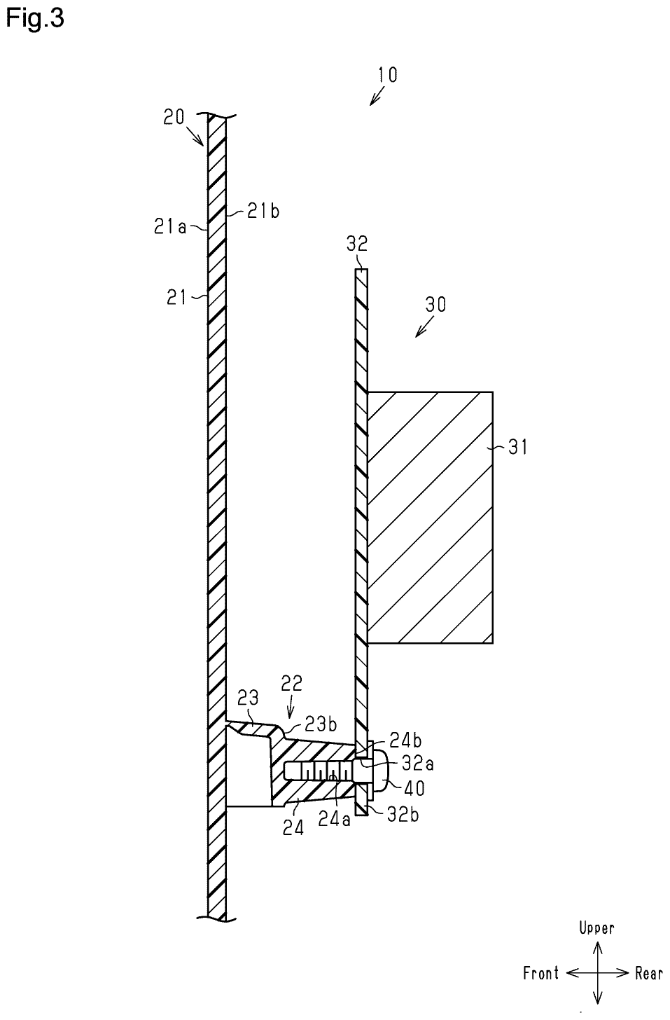

As shown in FIGS. 1 and 3, the first part 23 projects from the rear surface 21b of the exterior member body 21.

As shown in FIGS. 2 and 3, the first part 23 is hollow and open downward.

The second part 24 projects from a rear end surface 23b of the first part 23. The second part 24 includes a rear end surface 24b and a threaded hole 24a open in the rear end surface 24b.

As shown in FIG. 2, the threaded holes 24a of the three coupling portions 22 are arranged on a circumference of an imaginary circle C located on the rear surface 21b of the exterior member body 21. In the present embodiment, the three threaded holes 24a are arranged at intervals of 120 degrees, or equiangular intervals, about the center of the imaginary circle C.

### Vibrator 30

As shown in FIGS. 1 and 3, the vibrator 30 is arranged at the rear side of the exterior member body 21.

The vibrator 30 includes a vibration generator 31 that vibrates when energized and a fixing plate 32.

The fixing plate 32 has the form of a circular plate. The fixing plate 32 is substantially equal in size to the imaginary circle C. The fixing plate 32 includes projections 32b projecting outward from the circumference of the fixing plate 32 and coupled to the second parts 24 of the coupling portions 22. When the projections 32b are in contact with the rear end surfaces 24b of the second parts 24, screws 40 are inserted into through holes 32a of the projections 32b and engaged with the threaded holes 24a. Thus, the fixing plate 32 is coupled to the coupling portions 22.

The vibration generator 31 is fixed to a central portion of the rear surface of the fixing plate 32. The vibration generator 31 is fixed to the fixing plate 32 by, for example, an adhesive. The vibration generator 31 is electrically connected to a controller (not shown). The frequency of vibration of the vibration generator 31 is controlled by the controller.

The sound output device 10 having the configuration described above vibrates the exterior member body 21 using vibration of the vibrator 30 propagated through the coupling portions 22 and outputs sound waves generated in accordance with the vibration of the exterior member body 21.

A diameter R of the imaginary circle C and a frequency of vibration of the vibrator 30 are set so that vibrations propagated through the coupling portions 22 intensify each other in the center of the imaginary circle C of the exterior member body 21.

Preferably, the frequency of vibration of the vibration generator 31 is greater than or equal to 100 Hz and less than or equal to 2000 Hz. More preferably, the frequency of vibration of the vibration generator 31 is greater than or equal to 500 Hz and less than or equal to 1000 Hz.

Preferably, the diameter R of the imaginary circle C is greater than or equal to 50 mm and less than or equal to 250 mm. More preferably, the diameter R of the imaginary circle C is greater than or equal to 70 mm and less than or equal to 130 mm.

### EXAMPLES OF VIBRATOR 30

### Example 1

The diameter R of the fixing plate 32 is 90 mm. The thickness of the fixing plate 32 is 4 mm. The fixing plate 32 is formed from an acrylonitrile butadiene styrene (ABS) resin.

### Example 2

The diameter R of the fixing plate 32 is 90 mm. The thickness of the fixing plate 32 is 2 mm. The fixing plate 32 is formed from an acrylonitrile butadiene styrene (ABS) resin.

### Example 3

The diameter R of the fixing plate 32 is 100 mm. The thickness of the fixing plate 32 is 1 mm. The fixing plate 32 is formed from aluminum.

### Example 4

The diameter R of the fixing plate 32 is 100 mm. The thickness of the fixing plate 32 is 2 mm. The fixing plate 32 is formed from aluminum.

### Example 5

The diameter R of the fixing plate 32 is 100 mm. The thickness of the fixing plate 32 is 3 mm. The fixing plate 32 is formed from aluminum.

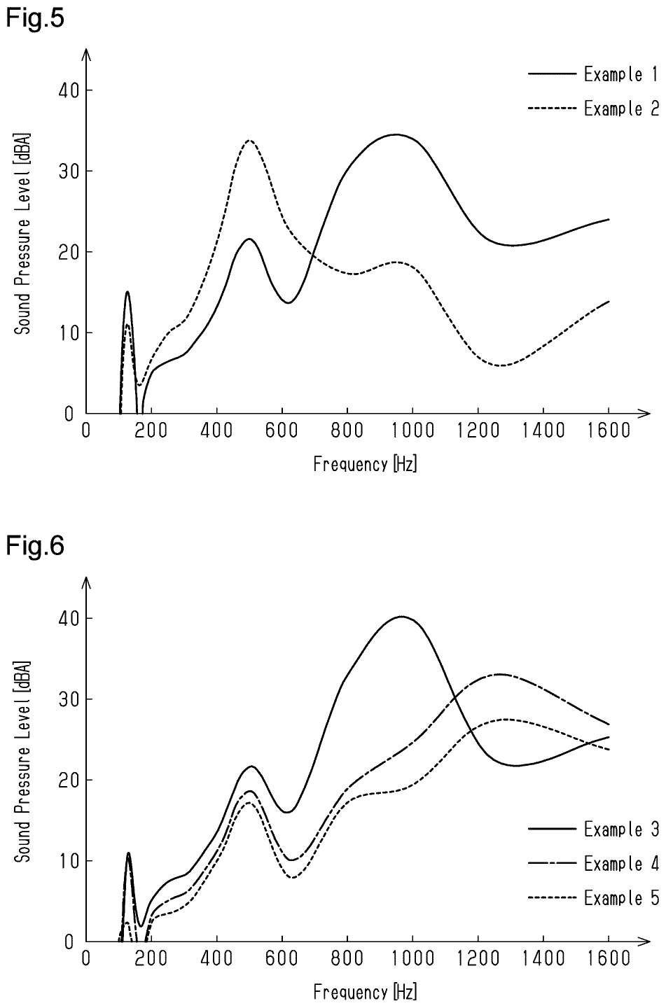

FIG. 5 shows the relationship between the frequency and the sound pressure level of sound waves generated in accordance with vibration of the exterior member body 21 when the fixing plate 32 is formed from a hard resin.

FIG. 6 shows the relationship between the frequency and the sound pressure level of sound waves generated in accordance with vibration of the exterior member body 21 when the fixing plate 32 is formed from metal.

In FIGS. 5 and 6, the sound pressure level is an A-weighted sound pressure level.

FIGS. 5 and 6 show simulation results obtained by using a sample of a square plate having a side of 150 mm and a thickness of 3 mm as the exterior member body 21.

As shown in FIG. 5, the sound pressure level at frequencies of approximately 700 Hz to 900 Hz in Example 1 is higher than the sound pressure level at frequencies of approximately 700 Hz to 900 Hz in Example 2. Also, the sound pressure level at frequencies of approximately 900 Hz to 1100 Hz in Example 1 is higher than the sound pressure level at frequencies of approximately 900 Hz to 1100 Hz in Example 2.

As shown in FIG. 6, the sound pressure level at frequencies of approximately 700 Hz to 900 Hz in Example 4 is higher than the sound pressure level at frequencies of approximately 700 Hz to 900 Hz in Example 5. The sound pressure level at frequencies of approximately 900 Hz to 1100 Hz in Example 4 is higher than the sound pressure level at frequencies of approximately 900 Hz to 1100 Hz in Example 5.

The sound pressure level at frequencies of approximately 700 Hz to 900 Hz in Example 3 is higher than the sound pressure level at frequencies of approximately 700 Hz to 900 Hz in Example 4. The sound pressure level at frequencies of approximately 900 Hz to 1100 Hz in Example 3 is higher than the sound pressure level at frequencies of approximately 900 Hz to 1100 Hz in Example 4.

### Operation of Present Embodiment

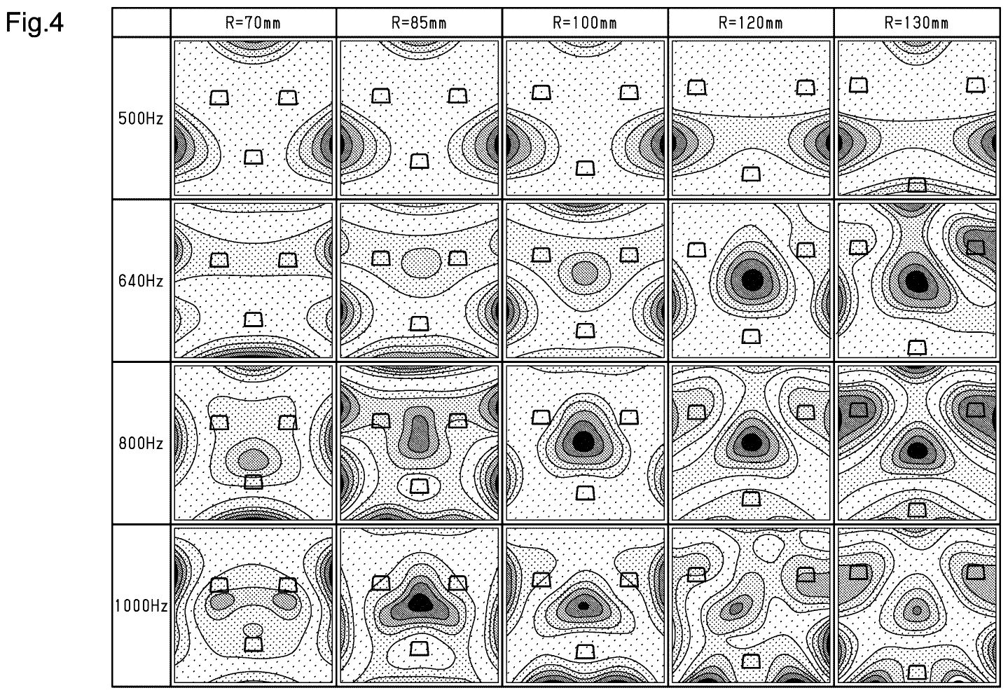

FIG. 4 shows the relationship of the diameter R of the imaginary circle C, the frequency of the vibration generator 31, and the distribution of absolute values of amplitude of vibration of an exterior member body 21. The fixing plate 32 is formed from a hard resin. FIG. 4 shows simulation results obtained by using a sample of a square plate having a side of 150 mm and a thickness of 3 mm as the exterior member body 21.

At 500 Hz frequency of vibration of the vibration generator 31, the absolute value of amplitude of the vibration is increased in the center of the imaginary circle C when the diameter R of the imaginary circle C is 120 mm and 130 mm. In FIG. 4, the density of dots increases as the absolute value of amplitude of the vibration increases.

At 640 Hz frequency of vibration of the vibration generator 31, the absolute value of amplitude of the vibration is increased in the center of the imaginary circle C when the diameter R of the imaginary circle Cis 85 mm, 100 mm, 120 mm, and 130 mm. In particular, when the diameter R of the imaginary circle C is 120 mm and 130 mm, the absolute value of amplitude of the vibration is increased in the center of the imaginary circle C.

At 800 Hz frequency of vibration of the vibration generator 31, the absolute value of amplitude of the vibration is increased in the center of the imaginary circle C when the diameter R of the imaginary circle C is 70 mm, 85 mm, 100 mm, 120 mm, and 130 mm. In particular, when the diameter R of the imaginary circle C is 100 mm, 120 mm, and 130 mm, the absolute value of amplitude of the vibration is increased in the center of the imaginary circle C.

At 1000 Hz frequency of vibration of the vibration generator 31, the absolute value of amplitude of the vibration is increased in the center of the imaginary circle C when the diameter R of the imaginary circle C is 70 mm, 85 mm, 100 mm, 120 mm, and 130 mm. In particular, when the diameter R of the imaginary circle C is 85 mm and 100 mm, the absolute value of amplitude of the vibration is increased in the center of the imaginary circle C.

In the sound output device 10 of the present embodiment, vibrations propagated through the coupling portions 22 overlap each other and are intensified in the center of the imaginary circle C located on the rear surface 21b of the exterior member body 21. In this configuration, components of the exterior member body 21 located outside the imaginary circle C have a negligible effect on vibration present inside the imaginary circle C.

### Advantages of Present Embodiment

(1) The diameter R of the imaginary circle C and the frequency of the vibration of the vibrator 30 are set so that vibrations propagated through the coupling portions 22 intensify each other in the center of the imaginary circle C of the exterior member body 21.

With this configuration, the above-described operation is obtained. Therefore, even when the exterior member bodies 21 have different sizes and shapes, sound waves having a predetermined frequency are output from the center of the imaginary circle C outward beyond the exterior member body 21.
(2) The frequency of the vibration generator 31 is greater than or equal to 100 Hz and less than or equal to 2000 Hz. The diameter R of the imaginary circle C is greater than or equal to 50 mm and less than or equal to 250 mm.

With this configuration, the sound output device 10 is embodied as an approach notification sound.

### Modified Examples

The above embodiment may be modified as described below. The present embodiment and the following modified examples can be combined as long as the combined modified examples remain technically consistent with each other.

The fixing plate 32 is not limited to a hard resin and may be metal.

In the present embodiment, the coupling portions 22 are arranged at equal intervals on the imaginary circle C. However, the coupling portions 22 may be changed to any position on the imaginary circle C.

In the present embodiment, the three coupling portions 22 are arranged. However, the number of coupling portions 22 may be two or four or more.

The fixing plate 32 is not limited to a circular shape and may be a polygon such as a quadrilateral. In this case, it is preferred that each vertex of the polygon is located on the same circle. In addition, it is preferred that the coupling portions 22 are provided at each position corresponding to the vertex of the polygon.

The exterior member 20 is not limited to a front cover and may be any member forming a portion of the outer shell of the vehicle such as a rear door, a fender panel, a bumper, or a roof.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A sound output device for a vehicle, the sound output device, comprising:
an exterior member body including a portion of an outer shell of the vehicle;
a vibrator arranged at an inner side of the vehicle with respect to the exterior member body and configured to vibrate when energized; and
coupling portions projecting from an inner surface of the exterior member body and connecting the exterior member body to the vibrator, wherein
the sound output device is configured to vibrate the exterior member body using vibration of the vibrator propagated through the coupling portions and output a sound wave generated in accordance with the vibration of the exterior member body to an outside of the vehicle,
the coupling portions are arranged on a circumference of an imaginary circle located on the inner surface of the exterior member body, and
a diameter of the imaginary circle and a frequency of the vibration of the vibrator are set so that vibrations propagated through the coupling portions overlap each other and are intensified in a center of the imaginary circle of the exterior member body.

2. The sound output device according to claim 1, wherein
the frequency is greater than or equal to 100 Hz and less than or equal to 2000 Hz, and
the diameter of the imaginary circle is greater than or equal to 50 mm and less than or equal to 250 mm.
